(19) United States
(12) Patent Application Publication
(10) Pub. No.: US 2012/0007707 A1
(43) Pub. Date: Jan. 12, 2012

(54) NON-CONDUCTIVE LID FOR TRANSFORMERS

(76) Inventor: George Matai, Oakville (CA)

(21) Appl. No.: 13/257,155

(22) PCT Filed: Mar. 17, 2010
(86) PCT No.: PCT/CA2010/000402

§ 371 Date: Sep. 16, 2011

Related U.S. Application Data
(60) Provisional application No. 61/160,760, filed on Mar. 17, 2009.

(51) Int. Cl. H01F 27/02; B23P 11/00

(52) U.S. Cl. 336/90; 29/428

(57) ABSTRACT

The present invention is an electrically non-conductive transformer lid that may replace the top of the housing of a transformer or be attached to the housing of a transformer. The lid may isolate an animal that is in contact with the lid from the ground grid, even if the animal attempts to make contact with the energized primary conductor or other apparatuses. The present invention thereby prevents electric current from flowing through the animal's body to the ground and prevents outages or electric faults from occurring. It may be attachable to a variety of known types of transformers, including pole-mounted distribution transformers. The means of attaching and removing the lid may be performed by a single person. The lid may be shaped to prevent moisture or other particulates from entering the transformer and thereby further protect the function of the transformer.

### FIELD OF INVENTION

This invention relates in general to the field of power transformers and more particularly to a transformer lid that is electrically non-conductive.

### BACKGROUND OF THE INVENTION

A variety of transformers may be utilized in the provision of electricity to communities. In particular, pole-mounted distribution transformers are used frequently, but not exclusively, by electric utilities to step down the voltages to utilization level near the service entrance of residential homes and commercial and industrial facilities. Pole-mounted distribution transformers are installed on hydro poles to reduce the higher distribution voltage (e.g., 27600/16000 volts, 13800/8000 volts, 4160/2400 volts, etc.) to a utilization level of voltage (e.g., 120/240 volts, 347/600 volts, etc.).

Pole-mounted distribution transformers are fabricated by various companies for different capacities ranging from, but not limited to, 25 KVA (kilovolt-ampere), 50 KVA, 75 KVA, 100 KVA, and 167 kVA. The primary and secondary voltages of these transformers may also vary depending on the application of use for which a particular transformer is intended. The typical primary distribution voltages, both of three phase and single phase, are 27.6 KV (kilovolt), 16 KV, 13.8 KV, 8 KV, 4.16 KV, 2.4 KV, 8.3 KV, and 4.8 KV. The secondary voltages may also vary depending on the utilization voltages of the intended customer. Typical utilization voltages are 120/240V (volts), and 347/600V.

Pole-mounted distribution transformers are also manufactured to step down the primary voltages from one level to another level of voltage, for example from 16 KV to 8 KV. Such a pole-mounted transformer is referred to commonly as a “Rabbit”. These transformers are routinely used by the electric utility companies during voltage conversion and upgrade projects.

Generally in the field of transformers, as the KVA rating of a transformer increases the physical size of the transformer will increase in a corresponding manner. The size of the pole-mounted transformer may also depend on the primary and the secondary voltages of the transformer.

Typically the pole-mounted transformers are fabricated by various companies in a cylindrical shape. The tank and lid of such transformers may be fabricated using electrically conductive material (for example, such as steel, galvanized steel, etc.)

Other types of pole-mounted distribution transformers are three phase units. These units provide a three phase voltage to mainly business customers such as industrial and commercial facilities. The shape of such units is sometimes fabricated in a shape of a rectangular box. Also a combination of three single phase transformers is sometimes electrically connected by a wiring configuration operable to supply three phase customers.

Different companies manufacture transformers having different outlines or configurations. These outlines or configurations may also affect the size and configuration of the tank which the transformer coils are secured to. Accordingly, there is a multitude of sizes of distribution transformers on the market and in use. Several of these transformers are filled with insulating oil.

When put into service (i.e. transformers are mounted on a hydro pole to service one or more customers) the primary bushing of the transformers can be connected to the primary voltage conductor of the distribution line by a conductor or cable. The transformer tank and lid must be grounded to the neutral conductors of the distribution system. The tank and the lid must be bonded to the grounding conductor that runs along the distribution pole (e.g. hydro pole) to a grounding rod driven a few feet into the ground adjacent to the hydro pole. This installation is necessary in order for the transformer to function properly and to create a path to ground for the fault current.

Utility companies generally use common types of hydro poles. The most common ones are wood poles which causes some animals that climb the pole to have access to the height where the transformer is installed. The other types of poles commonly used by utilities are concrete and steels poles. Although, it is difficult for animals to climb these types of poles, due to the slippery or smooth surface conditions of such poles, animals can reach the top of these poles by climbing nearby trees or walking on the overhead wires and conductors to travel from pole to another. Of course, birds are able to reach the top of all types of poles.

A problem arises when animals make contact with sections of the transformer, particularly the bushing. An interruption may occur in the power supply as a result of animal contact. This frequently occurs during the evenings and nights.

Currently, there are products on the market used to minimize the effect of animal contacts to power lines. For example, U.S. Pat. No. 4,906,801 discloses a transformer cover lid. However, the patent does not disclose a means of replacing the transformer lid altogether. As a consequence the transformer could fail due to the pockets of water accumulating from rain and coming into contact with the transformer. Such water will become conductive when a contact is made at the primary or the secondary terminals of the transformer. The water particularly around the bushing of the transformer will reduce the arcing distance of the primary bushing of the transformer. Further, covering few skirts of the primary bushing will reduce the arcing distance the bushing was intended to isolate the primary voltage from in the transformer tank, this could have damaging consequences to the apparatus.

U.S. Pat. No. 5,648,641 also discloses an electrostatic animal barrier. This invention may discourage the animal from approaching the primary bushing. It will not, however, eliminate animal contacts with the secondary terminals of the transformer. Consequently, the disclosed invention does not prevent the animal from getting electrocuted by the electrostatic produced. The severity of such an electric shock will depend on many factors.

Other prior art attempts to address the problem of animal contact by covering the primary bushing of the transformer. However such prior art fails to address the problem as a whole. For example, the focus is upon covering the primary bushing of the transformer, but the threat posed by the grounding source of the transformer is not considered.

U.S. Pat. No. 3,599,134 discloses a transformer tank formed of non conductive material. The purpose of this patent is to deal with or to eliminate the rust issues that may develop within the transformer tank. The patent does not address the issue of animal contacts. Also, the method disclosed in this patent does not provide a means for reducing the heat generated by the transformer, which means the transformer will be prone to overheating. For this reason the invention is impractical to implement.

U.S. Pat. No. 3,305,812 discloses a transformer having an exterior finish. This invention is one form of a known coating applied to prior art pole-mounted transformers to give a minimum dielectric strength to the ground of the primary voltage. This process has not been effective in preventing power outages caused by animal contacts. This is because known transformer lids do not completely isolate animals contact with transformers from the grounding system

### SUMMARY OF THE INVENTION

In one aspect, the present disclosure relates to a transformer lid attachable to a transformer housing, said transformer housing incorporating a transformer being attached to a ground grid and having an electrical current flowing therethrough, characterized in that it comprises; a lid portion formed of electrically non-conductive material; and an attachment means operable to attach the lid portion to the transformer housing, said lid portion isolating any being in contact with the lid portion from the ground grid when the transformer lid is attached to the transformer housing.

In another aspect, the present disclosure relates to a method of preventing an animal landing upon a transformer from conducting electrical current flowing through the transformer, characterized in that it comprises the steps of: attaching an electrically non-conductive lid upon the transformer; and utilizing the electrically non-conductive lid to isolate the animal from a ground grid when said animal rests on the lid by preventing the electrical current flowing through the transformer from flowing to a ground.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 shows a view of the electrically non-conductive transformer lid of the present invention secured to a transformer tank.

FIG. 2 shows a view of the electrically non-conductive transformer lid of the present invention secured to a transformer tank with a securing rim.

FIG. 3 shows the electrically non-conductive transformer lid of the present invention secured to a pole mounted transformer.

FIG. 4 shows an exploded view of an embodiment of the present invention.

FIG. 5a shows a top view of a two-section securing rim.

FIG. 5b shows a top view of a two-section securing rim fitted around an outer lid portion.

FIG. 5c shows a side view of the electrically non-conductive transformer lid of the present invention having a securing rim secured to a transformer.

FIG. 5d shows a perspective view of the electrically non-conductive transformer lid of the present invention having a two-section securing rim.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

The present invention is an electrically non-conductive transformer lid that may replace the top of the housing of a transformer or be attached to the top of the housing of a transformer. The lid may isolate an animal that is in contact with the lid from the ground grid, even if the animal attempts to make contact with the energized primary conductor or other apparatuses. The result is that the electric circuit is prevented from being completed. The outcome of animal contact may be power outages that affect significant segments of the population and require many resources including, time, money and manpower, to correct. The present invention prevents electric current from flowing through the animal's body to the ground and as a result a power outage or electric fault that may otherwise occur may be avoided. Additionally, the present invention may prevent the animal from being electrocuted or harmed.

The present invention is a lid for a transformer that is formed of non-conductive materials and may be positioned at the top of a transformer housing. The lid of the present invention may cover the top of the transformer and/or may replace any other lid of the transformer. Several embodiments of the present invention are possible. For example, the lid of the present invention may be attached to the transformer housing in a close-fitting manner. Additionally, the lid may be attached to a variety of known types of transformers, including pole-mounted distribution transformers. Also, the means of attaching and removing the lid may be of several configurations. In one embodiment of the present invention it may be possible for a single person to perform the attachment and/or removal of the lid to/from the transformer.

The electrically non-conductive material forming the lid may include a variety of materials, for example, such as composite materials, plastics, fiberglass, as well as other materials. The characteristics of the non-conductive material utilized to form the lid may function so as to isolate an animal resting on the lid of a transformer from a ground grid. The result may be that when an animal makes contact with a primary live line the path of the electrical fault current is disconnected from the ground grid. The thickness of the material utilized to manufacture the lid may vary to result in the required properties and functions of the present invention, as described herein.

The present invention has several benefits over the prior art. Some prior art in this field is referred to as an “animal guard”. For example, animal guards may be a plastic cover that is installed on the primary bushing of the transformer to cover the connection point between the primary bushing and the primary conductor. Generally, even with an animal guard in place, it is possible for an animal to make contact with the primary or the secondary terminal, as well as with the low voltage terminals of the transformer. The event of animal contact with a secondary terminal may not cause a power outage, however it could kill or severely harm the animal. The present invention, formed of non-conductive material, functions so that an event of animal contact with a primary or secondary terminal may not result in any of: a power outage; the death of the animal; or serious harm to the animal.

Additionally, known prior art includes covers that encase parts of the primary bushing and the point of connection with the primary conductor, which incorporates high voltage. With such a prior art cover in place, a person who needs to access the whole of the primary bushing and in particular the connection point between the primary bushing of the transformer and the primary conductor, will be required to remove the cover. This can be a laborious effort made necessary because the prior art cover blocks direct access to the connection point. Additionally, it can be an effort that requires the involvement of more than one person, as the means of connecting the cover to the transformer can involve multiple attachment means.

The present invention overcomes the drawbacks of the prior art. Prior art covers provide a means of covering the primary bushing and parts of the transformer housing, but these covers do not alter the grounding source of the transformer. Embodiments of the present invention may replace or cover the top of the transformer housing with a lid formed of non-conductive material. This may alter the grounding source of the transformer. The result may be that an animal that rests upon the lid may be isolated from the ground grid, even if the animal attempts to make contact with the energized primary conductor or other apparatuses.

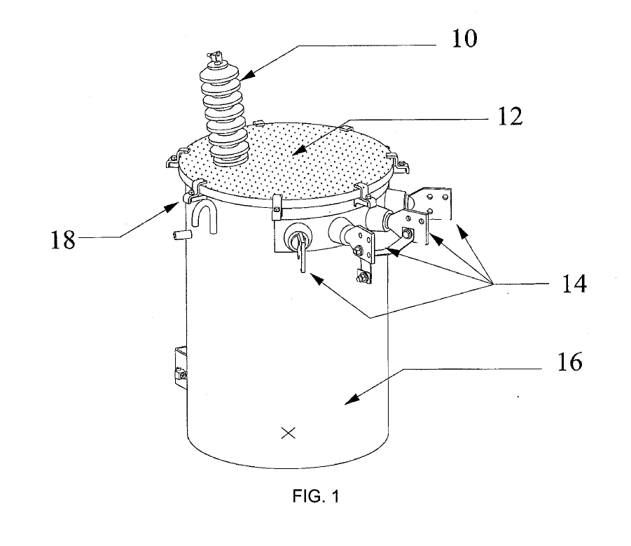

In one embodiment of the present invention, as shown in FIG. 1, the lid 12 of the present invention is closely-fitted upon the top of the transformer housing 16, so that access to the connection point of the primary bushing 10 may be unencumbered. Additionally, the lid may be designed to incorporate an attachment means 18 that is causes the lid to be easily attachable and removable from the transformer housing.

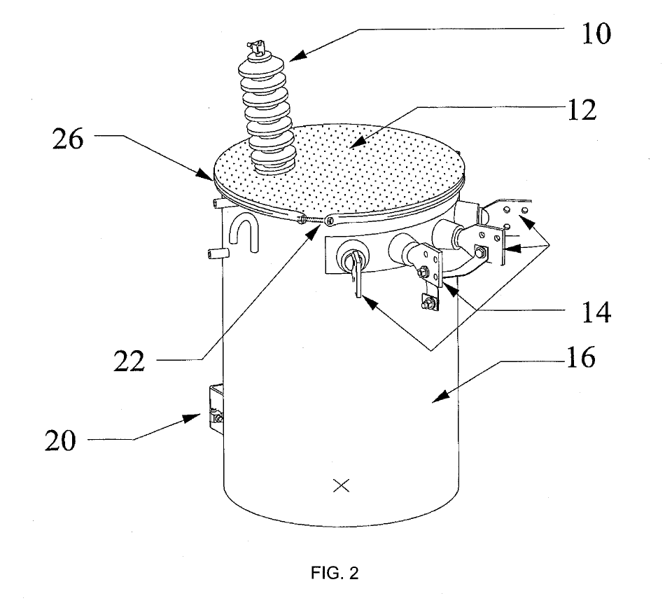

As shown in FIG. 2, an embodiment of the present invention may be removably attached by an attachment means 26 whereby a single attachment piece 22 may be utilized to attach or detach the lid from the transformer.

Further advantages of the present invention over the prior art are also notable. The lid of the present invention may protect animals from death that would otherwise result due to interaction with a transformer, for example, such as contact with the primary bushing 10 or the secondary terminals 14, as shown in FIG. 1. Animals rest on the transformer lid which is connected to the ground source and their limbs reach or touch at the energized parts of the distribution circuit completing the electric circuit. This outcome may have an environmental impact. In the case that animals making contact with the transformer are classified as endangered species, the present invention may help protect such species, as the random loss of such animals may contribute to their extinction. Additionally, the lid of the present invention may reduce operating expenses of electric utilities that otherwise incur costs in the course of attending to power outages caused by animal contact with a transformer.

Power interruptions to consumers or utility outages occur due to many different causes including equipment failure, tree contacts, conductors and pole breaks, transformers failures, wildlife and animal contacting parts of the distribution system, etc. Particular power interruptions are caused by wild animals such as birds, raccoons or squirrels. Animals may make contact with the energized power lines and apparatus of the distribution system and equipment such as pole-mounted transformers and thereby cause a power interruption. The physical contact of the animal to the live or energized conductor or apparatus can cause a short circuit between the live distribution lines and the ground or the neutral conductor (which is connected to the ground) causing an electrical fault at the point of contact resulting in an interruption to the electric service and usually killing or severely harming the animal in the process. Usually the animal will be found dead on the ground near the pole or it stays connected to the transformer. Additionally, wide-spread power outages can occur as a result of the animal contact with the transformer. Such power outages can affect significant numbers of hydro customers and require time and expense to fix.

As an example, animal contact with a pole-mounted distribution transformer can cause wide outages extending to all customers serviced by the particular feeder where the transformer is installed. A 50 KVA transformer will typically service approximately 10 residential customers, depending on how far apart the customers receiving power are located from one another in distance. The transformer may also supply traffic signals, street light and be the source of power to cable and telephone supply. All of these services are interrupted when a power outage occurs.

Frequently this form of interruption is a momentary interruption that takes place when the breaker of the transformer station must operate to fix the problem created when an animal contact takes place. These types of outages are very disturbing to customers, particularly when the outage lasts long enough to shut down computers and machineries that require re-setting and time to start-up after a power outage. The number of customers affected can reach into the hundreds or sometimes the thousands. It may include residential and commercial customers and result in loss of revenue to the electric utility company and a perceived reduction of its performance and reliability. For a medium size utility having approximately 60,000 residential, commercial and industrial customers, servicing combinations of urban and rural territories, the cause of outages related to animal contacts can represent as many as 20% of the overall utility outages.

Animal contact that occurs during off-hours, such as the evening or night hours, may create undue expense for the electric utility company that must be engaged in fixing the power outage. In such a case the utility company may be forced to pay for time and labor of a line crew at a premium rate (e.g., at an over-time rate). The line crew costs incurred to maintain the continuation of power will contribute to the electric utility company's operating expenses for unplanned work.

The number of power outages caused by wildlife in regions generally represent approximately between 6-9% of total outages. Unknown causes for power outages range approximately between 10-15% of total outages. Unknown causes may be caused by either fallen tree limbs or animal contact. In some instances the dates and time graphs for these unknown causes correspond to animal contact. Sometimes the animal culprit is not found by the line or construction crew sent to fix the cause of the power outage. Therefore, it would be safe to assume that animal contact is responsible for approximately between 8-12% of power outages on all system voltages. For rural areas that average may even be a few percentage points higher.

The present invention may enhance the performance of electric utilities by increasing revenue generated from selling electricity to end user customers. This may occur due to a reduction in the number of power interruptions per year as well as a shortened duration of such outages. These are events that are reported by electric utilities to industry regulators as performance indicators. A secondary, but also important outcome for an electric utility company that utilizes the present invention, may be that by reducing the number of interruptions to the flow of electricity a more positive image of the electric utility company will be portrayed to their customers.

An additional advantage of the present invention may be related to its shape and position as a lid on a transformer. The prior art covers for transformers, even those that are formed of non-conductive materials, may be shaped so as to cover the lower section of the transformer bushing. For example, the lower section of the transformer bushing may be located near the gasket. This type of cover may reduce the distance of the transformer bushing and compromise the leakage/creepage distance of an electric arc. The leekage/creepage distance may be the distance the arc current created by a voltage surge will travel along the primary bushing of the transformer before causing a flashover. A bushing may be created to withstand a specific basic impulse level or certain flashover point. The general purpose of the bushing of the present invention may be to permit a connection to the primary side of the transformer coil and to protect the transformer should a voltage surge occur. In the instance of a high voltage surge the current will travel along the primary bushing of the transformer from the point of connection at that top of the bushing. Due to this fact the primary bushing may be formed to be a specific size and length, in accordance with the basic impulse level required or specified by a manufacturer or client which accords with a specific use. By reducing the distance of the transformer bushing by the placement of a cover, as is disclosed in the prior art, the bushing may experience a flashover that causes the transformer to fail. Additionally, a flashover may cause the non-conductive material of the cover to become conductive. The result may be a flashover and/or transformer failure if a voltage surge occurs. Compromising the length or the shape of the primary bushing may create a likelihood of transformer failure, either in the short-term or in the long-term. The present invention may be shaped and positioned so as to not compromise the length or shape of the primary bushing and thereby avert transformer failure.

Prior art covers additionally may contain openings to provide ventilation for the transformer. Such openings present a drawback in that they can create a means for water, such as rainfall, to enter inside the cover. Such water can come into contact with the transformer. As the slots provide a means for water to enter the cover, without a draining means, accumulated water may cause the transformer tank to rust over time. Additionally the water may reduce the effectiveness of the non-conductive material of the cover and therefore an animal positioned upon the cover of the prior art may not be isolated from the high voltage conductor.

Yet another drawback of the prior art covers is that water caught inside such a cover may freeze during the winter season and then melt to return to a liquid state during the summer. The cycle of freezing and melting of the water that is in contact with the transformer and bushing may cause the bushing to crack. It may further cause the transformer to fail. The present invention may prevent water from accumulating near or in the transformer.

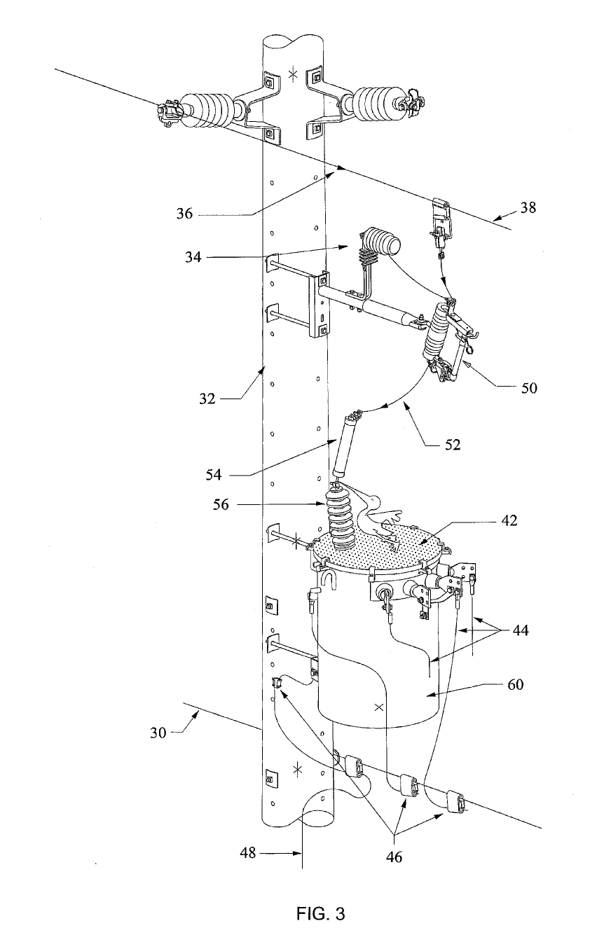

A further drawback of prior art covers is that they generally cannot be used with transformers that incorporate a current limiter fuse. As shown in FIG. 3, a current limiter fuse 54 may be mounted on the primary bushing 56 of a transformer 60 for the purpose of limiting the more severe type of electrical fault current on the higher level of distribution system, for example, such as 16 KV and over. Incorporating a current limiter fuse in a transformer may cause a prior art “animal guard” to be incompatible with the transformer, or at the very least to have limited application therewith. As shown in FIG. 3, the present invention may be compatible with a transformer that incorporates a current limiter fuse.

In one embodiment of the present invention, as shown in FIG. 3, a non-conductive lid 42 may isolate an animal that is in contact with the lid from the ground grid, even if the animal attempts to make contact with the energized primary conductor 52, or other apparatuses, such as the secondary drop leads 44 or the primary bushing 56. The result is that the electric circuit is prevented from being completed. The present invention thereby prevents electric current from flowing through the animal's body to the ground 48 and hence no outage or electric fault may occur and the animal may avoid electrocution.

In one embodiment of the present invention, the lid may be formed of a non-conductive material. The lid may be shaped to fit on the top of a transformer housing. Thus, the size and shape of the lid may vary depending on the type of transformer it is intended to fit upon as a lid. In one embodiment of the present invention, the circumference of the lid may be of the same circumference as the transformer lid in order to provide maximum area of coverage. In some embodiments the lid may have a lip or rim that extends down the side of the transformer housing.

In another embodiment of the present invention, an animal may be isolated from the ground grid by a non-conductive lid that either replaces the top of the transformer housing or fits onto of the top of the transformer in a closely-fitting manner. The lid of the present invention disconnects the path of the electric current flowing to the ground so that such current does not flow through an animal that rests upon the lid.

In known transformers the ground grid may be connected to the tank through a grounding strap. The grounding strap may be required by industry technical standards. In one embodiment of the present invention, as shown in FIG. 1, the ground strap may no longer be required. In such an embodiment the lid 12 of the present invention formed from non-conductive material, may cover and isolate the grounding strap. In another embodiment of the present invention, as shown in FIG. 2, a grounding strap 24 may be incorporated in the lid 12 and transformer housing 16.

Additionally, in one embodiment of the present invention, the internal support bracket or clamp of the primary bushing that is used to fasten and/or connect the primary bushing of the transformer to the lid of the present invention may be internally grounded. Said internal grounding may be achieved by connecting the primary busing through a grounding wire and/or strap to the grounding knob of the tank. This configuration may cause any lightning strikes hitting the pole to which the transformer is connected, or hitting the transformer, to the ground.

The lid of the present invention may be fabricated from a non-conductive material, for example, such as plastic, composite material, fiberglass, rubber, or any other material that is non-conductive. For example, one embodiment of present invention the lid, and any rim of the lid, may be manufactured using fiber glass insulation material.

In one embodiment of the present invention, the thickness and other characteristic of the material that forms the lid may be chosen to be capable to withstand the isolation capability of the related primary voltage of the transformer. For example, an embodiment of the present invention the lid, and any sealing rim of the lid, may be manufactured of material, for example, such as fiber glass insulation, having a thickness of 3/16 of an inch. A skilled reader will recognize that other materials and thicknesses are possible to be utilized for the present invention.

The insulating capability of the non conductive transformer lid of the present invention may be able to function to isolate the rated line-to-ground voltage of a distribution system voltage with which the transformer is intend to be used. Some pole mounted distribution transformers are intended for single phase application. Should the lid of the present invention be utilized with such a transformer then the insulation capability of the lid should be of a level that may isolate the rated line-to-ground voltage. Such an insulating capability level may be sufficient to isolate an animal in contact with the lid and prevent electrical contact.

For example, if a three phase distribution system voltage is 27,600 volts the rated single line-to-ground voltage may be 16,000 volts, and consequently a lid of the present invention may be manufactured using non conductive material having insulation properties and specifications sufficient to isolate the rated single line-to-ground voltage. In the case of a three phase application having three single phase transformers connected together to form a “transformer bank” to supply a three phase load, each of the transformers' primary voltage may be the line-to-ground voltage of the distribution system. Therefore, should the rated insulation level of the non conducive lid be of line-to-ground voltage, this should be a sufficient to isolate contact with the lid from electrical contact.

Electricity utility companies may operate multi voltage three phase distribution systems. For example, such systems may produce voltages such as 4.16/2.4 KV, 13.8/8 KV, 27.6/16 KV. In some instances transformers may be designed for dual voltage uses, whereby the primary voltage of the transformer will be sufficient for use on two different voltages, such as, for example 8,000 volts and 16,000 volts. For application with such a transformer the rated insulation properties of the non conductive lid may be rated to the highest voltage level.

In one embodiment of the present invention, the insulating rating of the material properties of the non conductive lid may be capable of isolating the highest single line-to-ground voltage of a transformer with which the lid may operate. This may have the benefit of reducing the need to manufacture the present invention from a variety of materials having different insulating ratings. In the case that the lid is to be utilized with a dual voltage transformer the highest distribution voltage capacity of the transformer should be utilized to determine the insulating rating of the material from which the lid may be manufactured. In such a case the non conductive lid must be manufactured with non conductive material having characteristics capable of insulating the highest rated line-to-ground voltage of the transformer. A skilled reader will recognize how this determination may be applied to all types of transformers, including any transformers not referenced specifically in this application.

The lid may be utilized with transformers that are currently in service, may be incorporated in transformers at the point of manufacturing, or may be attached to a transformer at any other appropriate time when such a lid is needed.

In yet another embodiment of the present invention, the non-conductive lid may be formed of a material that is non-breathable when installed and attached to the top of the transformer housing. The lid may be constructed of sufficient strength to withstand a pressure, for example, such as a pressure of 50 KPa, without leakage or permanent distortion of the tank under normal operation. The lid may also be constructed to be capable of withstanding an internal pressure under fault conditions.

In another embodiment of the present invention, the lid may be shaped to include a tapered or angled lip, whereby substances, for example, such as water or dust, may be drained from the lid to virtually prevent accumulation of the substance or particulates on the transformer. The angled lip may further be shaped so as to ensure virtually no contact occurs between the substance or particulates and the transformer housing.

In yet another embodiment of the present invention, the lid provides a surface of non-conductive material that is closely-fitted, so as to be virtually incorporated into the top of the transformer housing. In such an embodiment very little space will exist between the lid and the top of the transformer housing. Such an embodiment does not interfere with the heating of the transformer and therefore may not necessarily require specific ventilation means. Although, some embodiments of the present invention may include ventilation means. Additionally, an embodiment of the present invention which does not allow for significant space between the lid and the transformer housing prevents substances, such as water, from becoming trapped between the lid and the transformer housing. Trapped substances, such as water, can interfere with the function and longevity of the transformer, as discussed above, the present invention may prevent such problems of the prior art.

In one embodiment of the present invention, the lid may be attached to the top of the transformer housing by one or more attachment means. The one or more attachment means may function to provide ease of attachment and removal of the lid from the transformer housing. As shown in FIG. 2, the attachment means may include a sealing rim, such as a collar piece 26, that can be positioned so as to encompass the lip of the lid 12 when the lid is placed upon the transformer housing 16. The collar piece 26 is a single continuous piece having two unattached ends. The ends may be attached by way of an attachment piece 22, such as a clip, or a screw mechanism. For example, in order to attach the lid to the transformer housing, the attachment piece may be applied to cause the unattached ends to be drawn closer together, thereby creating tension in the collar piece whereby the collar piece holds the lid in firmly in place upon the transformer housing. In order to remove the lid from the transformer housing, the attachment piece may be attached to the transformer housing may be applied to cause the unattached ends to be drawn apart from one another, thereby releasing the tension in the collar piece to a point when the collar piece and the lid may be lifted off of the transformer housing. The collar piece and the lid may be lifted either together or separately from the transformer housing.

In one embodiment of the present invention, the attachment means of the present invention may be attachable and removable by a single person.

Other attachment means may be applied in the present invention. As shown in FIG. 1, if the transformer housing 16 includes a lip around its upper portion, one or more securing brackets 18 may be applied at intervals around the circumference of the housing. The securing brackets may attach the lid 12 to the transformer housing 16 in a non-permanent secure manner.

In other embodiments of the present invention, other attachment means may be utilized. Such attachment means may attach the lid of the present invention to the transformer housing in a permanent or non-permanent manner.

In one embodiment of the present invention, the non-conductive lid electrical isolation capability may have sufficient dielectric strength to withstand isolation of the primary voltage level of the distribution system.

In another embodiment of the present invention, the lid may conform to applicable standards for UV protection.

In yet another embodiment of the present invention, the lid may be secured on a transformer that is mounted upon a mounting means. As shown in FIG. 2 a bracket 20 may be incorporated in the transformer housing 16 to facilitate mounting of the transformer.

As shown in FIG. 3, the lid 42 may be incorporated into a pole-mounted transformer. In such an embodiment a transformer 60 may be mounted upon a pole 32 so as to be in contact at its lower end with a transformer grounding 46 that is further in contact with a system ground 48 and a system neutral 30. At its upper end the transformer 60 may be connected to an energized primary conductor 52, by way of a primary bushing 56, which may further be connected to a current limiter fuse 54. The energized primary conductor 52 may further connect to fuse 50 which has connections to a surge arrestor 34 and a primary conductor 38. An electric current flow 36 is attached to the primary conductor 38 and electrical current is thereby provided to the pole-mounted transformer. A skilled reader will recognize that the embodiment of FIG. 3 is but one configuration of a pole-mounted transformer incorporating the lid of the present invention and that other configurations are possible.

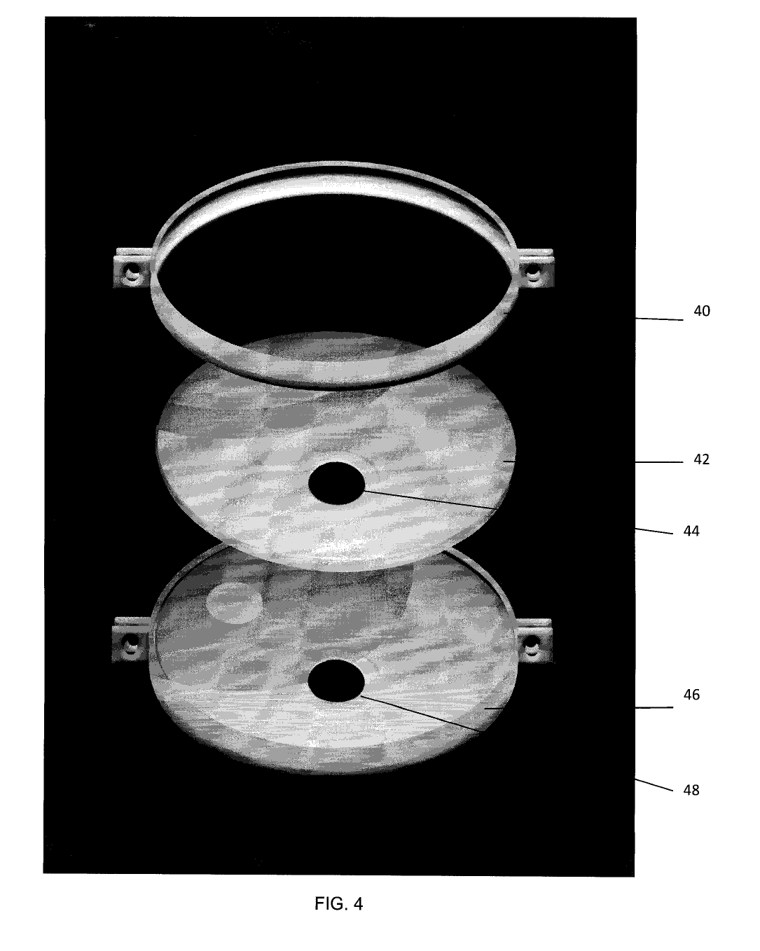

In yet other embodiments of the present invention the attachment means may be a sealing rim that includes one or more rim pieces 42, as shown in FIG. 4. The rim pieces may be fastened together by an attachment piece, for example, such as by one or more bolts or other attachment pieces. The sealing rim pieces 42 may encompass an outer lid portion 44. Said outer lid portion may include a hole 44, shaped to allow the primary bushing to pass through the hole. In this manner the primary bushing may extend beyond the edge of the outer lid portion when the lid is assembled and connected to a transformer. The outer lid portion may be positioned on the outside of the lid, and thereby in contact with the elements (e.g., wind, snow, etc.), when the lid is assembled and attached to a transformer.

The lid may also include an inner lid portion 46. The inner lid portion may be shaped so that the inner lid portion and outer lid portion may fit together. For example, as shown in FIG. 4, the outer lid portion may fit within the inner lid portion and the rim pieces may further fit around the joined outer lid portion and inner lid portion. The inner lid portion may also have a hole 48 shaped to allow the primary bushing to pass through the hole. The holes of the outer lid portion and inner lid portion may be aligned when the inner lid portion and outer lid portion are fitted together.

A skilled reader will recognize that a number of shapes and means of fitting the inner lid portion and outer lid portions together may be utilized, such as rims sized to correspond to one another, for example, the circumference of the rim of the outer lid portion being slightly smaller than that of the inner lid portion, or other means. The shape and connection between the inner lid portion and the outer lid portion may have several benefits. For example the connection may cause the lid to be water and wind-resistant and thereby protect the transformer from effects of wind or accumulation of other elements, such as snow, rain, dust, etc., when the lid is attached to the transformer. The shape and connection may further create improved levels of conductivity of electricity to enhance the function of the present invention.

For example, the outer lid portion may be shaped to be rounded or angled in a manner whereby rain, snow, dust or other particulates landing upon the outer lid portion will be drawn away from the lid and the transformer. In this manner the moisture or other particulates may be prevented from entering the transformer. Alternatively, or additionally, the inner lid portion may further be shaped to trap moisture or other particulates away from the transformer and thereby prevent these from entering the transformer. It is also possible that the outer lid portion and inner lid portion may be shaped and fit together in a manner that virtually or wholly prevents moisture or other particulates from entering the transformer. This embodiment of the present invention may thereby prevent problems that would otherwise be caused by moisture or other particulates entering the transformer from occurring, such as those discussed previously.

The shape and dimensions of the lid of the present invention may further be chosen to correspond to the size of a particular transformer which the lid is to be attached to.

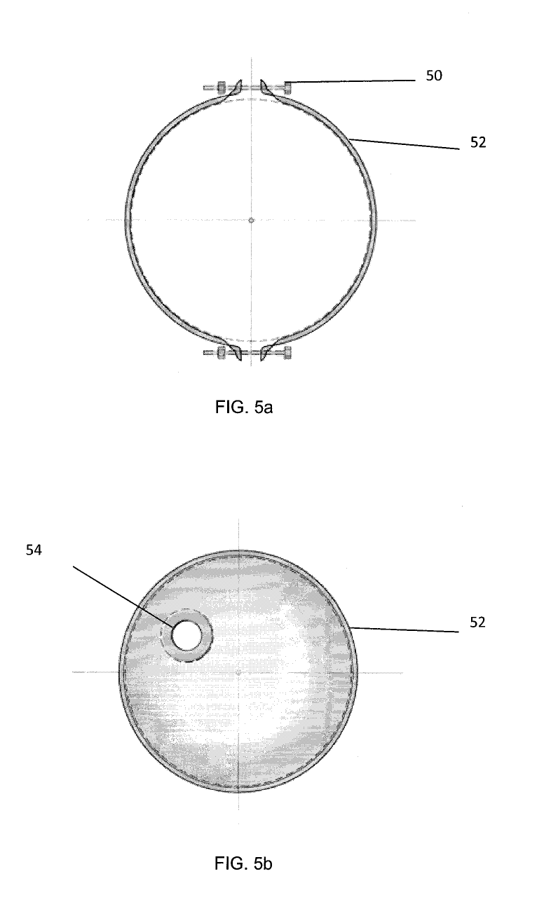

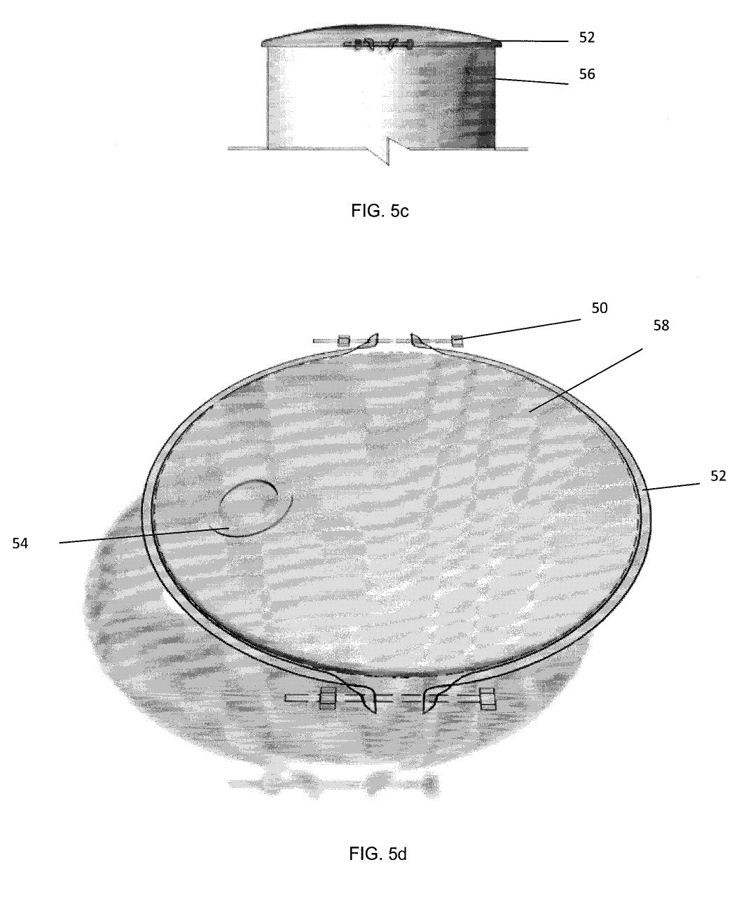

FIG. 5a-5d show a lid of the present invention having a two-section sealing rim. The sealing rim pieces 52, may be connected by way of one or more bolts 50, or other connection means, as shown in FIG. 5a. The sealing rim may be positioned around a lid portion 58. The lid portion may have a hole 54 shaped therein to allow a primary bushing to extend through the hole. When assembled, as shown in FIG. 5d, the lid may be attached to a transformer 56, as shown in FIG. 5c.

When the lid is attached to the transformer, the lid portion may be attached to the transformer in a manner that creates a seal between the transformer and the lid when the sealing rim is positioned around the lid portion and the connection means are tightened to create a close or tight-fit between the lid portion and the transformer. Tightening the connection means may have the effect of increasing the close or tight-fit between the lid portion and the transformer by reducing the space between the lid portion and the transformer. A skilled reader will recognize that other embodiments of the present invention may utilize a variety of means to create a seal, a close-fit, or a tight-fit between the lid and the transformer.

The following description includes details of two tests performed on embodiments of the present invention. The first describes a basic impulse lightning test, and the second a pressure and sealing test. These tests exemplify some of the functions and benefits of the present invention. The tests further exemplify that embodiments of the present invention may be configured to meet industry standards.

Basic Impulse Lightening Test

A test was performed in accordance with IEEE C57.12.00-2000, IEEE Standard General Requirements for Liquid-Immersed Distribution section 5.11, Power, and Regulating Transformers, IEEE c57.12.90-1999 IEEE Standard Test Code for Liquid-Immersed Distribution Power, and Regulating Transformers section 11. This test involved a transformer manufactured by C.E.S. Transformer, that was pole mounted by way of a single phase having dimensions of 0.6 meter in diameter and 1.0 meter in height. The transformer included a 16,000 Volt primary voltage terminal. The tank of the transformer was manufactured of galvanized steel. The embodiment of the present invention utilized was a lid that included a sealing rim, and was formed of fiberglass.

To capture the results of the test a Passonh Villa brand data acquisition meter was utilized. The calibration of the instruments undertaken for the test followed steps in compliance with the requirements of the National Research Council of Canada standards and approval.

The test involved a basic impulse lightening (BIL) test being performed on the primary terminal of busing H1. The transformer had a lid of the present invention attached. The test was performed on the primary bushing, while the secondary terminals were open as no coil on secondary. A reduced impulse was first applied to each of the tested terminal. The test involved impulses from 30 KV BIL to full wave impulses being applied to high voltage terminal.

For the primary terminal the impulse was applied at 1.6 μsec and a tail of 45 μsec. The crest of the impulse had a value of 62 KV for the first reduced wave. The crest of the full wave had a value of 175 KV. The waveform used negative polarity.

The result of the test was that the 50 KVA single phase pole mounted transformer passed the BIL test to the specifications identified by IEEE C57.12.00-2000. There was no obvious variation between the full wave and the reduced wave form used during the test. Additionally there was no visual or sound variations during the test.

Pressure and Sealing Test

A second test was performed involving a transformer manufactured by C.E.S. Transformer, that was pole mounted by way of a single phase having dimensions of 0.6 meter in diameter and 1.0 meter in height. The transformer included a 16,000 Volt primary voltage terminal. The tank of the transformer was manufactured of galvanized steel. The embodiment of the present invention utilized was a lid that included a sealing rim, and was formed of fiberglass.

To capture the results of the test a pressure measuring device was utilized. The calibration of the instruments undertaken for the test followed steps in compliance with the requirements of the National Research Council of Canada standards and approval.

The test involved the lid of the present invention including a rim formed of fiberglass. The lid was attached to the transformer. The transformer was pressurized up to 7.25 PSI in accordance with IEEE standards. The transformer was placed in an outdoor environment and returned there over a period of 27 days, in between a series of tests performed indoors. Specifically, the transformer was brought to an indoor environment where it was subjected to a variety of temperatures, humidity levels, and other simulated weather and environmental conditions. Each day the internal pressure of the transformer was measured. These measurements were utilized to monitor the pressure maintained by the transformer over the 27 day testing period.

Upon the final day, the internal pressure of the transformer was measured and recorded to be 2.5 PSI. This pressure indicated that the transformer had maintained an operating pressure that was within a desired range as well as in accordance with relevant industry standards. Additionally, the inspection of the transformer and lid upon the final day showed that the embodiment of the lid of the present invention that was attached to the transformer maintained the required operating conditions.

The result of the test showed that the 50 KVA single phase pole mounted transformer passed the pressure test with no signs of crack or deformation. The lid having a sealing rim maintained the required internal operating pressure of the transformer. The lid further isolated the transformer from the atmospheric pressure. Additionally, the lid functioned so that none to minimal moisture seeped within the transformer.

It will be appreciated by those skilled in the art that other variations of the embodiments described herein may also be practiced without departing from the scope of the invention. Other modifications are therefore possible.

We claim:

1. A transformer lid attachable to a transformer housing, said transformer housing incorporating a transformer being attached to a ground grid and having an electrical current flowing therethrough, characterized in that it comprises;
(a) a lid portion formed of electrically non-conductive material incorporating a grounding wire, said grounding wire connecting a primary bushing of the transformer to a grounding knob of a tank to achieve internal grounding; and
(b) an attachment means operable to attach the lid portion to the transformer housing, said lid portion isolating any being in contact with the lid portion from the ground grid when the transformer lid is attached to the transformer housing.

2. The transformer lid of claim 1, characterized in that the attachment means may be operable by one or more users to: attach the transformer lid to the transformer housing; to detach the transformer lid to the transformer housing; or to attach and detach the transformer lid to and from the transformer housing.

3. The transformer lid of claim 1, characterized in that the isolation of any being in contact with the lid portion from the ground grid when the transformer lid is attached to the transformer housing prevents a power outage and serious harm to the being.

4. The transformer lid of claim 1, characterized in that the transformer lid attached to the transformer housing functions to disconnect a path of the electric current flowing to the ground grid so that said electric current does not flow through any being in contact with the transformer lid.

5. The transformer lid of claim 1, characterized in that the lid portion and attachment means are shaped so that the transformer lid is closely fit when attached to the transformer housing.

6. The transformer lid of claim 1, characterized in that the attachment means is a sealable rim.

7. The transformer lid of claim 6, characterized in that the sealable rim comprises one or more rim pieces and one or more attachment fittings, said attachment fittings being operable to attach at least one of the one or more rim pieces to at least one other of the one or more rim pieces, and the sealable rim fits around the exterior of the lid portion when the transformer lid is attached to the transformer housing, said sealable rim forming a seal between the transformer lid and the transformer housing when the one or more attachment fittings are applied.

8. The transformer lid of claim 1, characterized in that the transformer lid attaches to the transformer housing in a manner that prevents moisture or any particulates from entering the transformer housing.

9. The transformer lid of claim 1, characterized in that the transformer lid is shaped to be angled so as to any drain moisture that may land upon the lid portion from the transformer housing.

10. The transformer lid of claim 1, characterized in that the transformer lid provides unencumbered access to a connection point of a primary bushing of the transformer.

11. The transformer lid of claim 1, characterized in that the transformer lid covers a primary bushing of the transformer to preserve a source of the ground grid of the transformer as applied before the transformer lid is attached to the transformer housing.

12. The transformer lid of claim 1, characterized in that the transformer lid is attachable to a pre-formed standard-sized transformer or a custom shaped transformer.

13. The transformer lid of claim 1, characterized in that the lid portion is formed of electrically non-conductive material that is one of the following: plastic, composite material, fiberglass, or rubber.

14. The transformer lid of claim 13, characterized in that the lid portion is formed of electrically non-conductive material that is fiberglass insulation material.

15. The transformer lid of claim 1, characterized in that the lid portion and attachment means are formed to withstand internal pressure under fault conditions.

16. The transformer lid of claim 1, characterized in that a primary bushing of the transformer may include an internal support bracket or clamp that is internally grounded and is further operable to fasten the primary bushing to the transformer lid claim.

17. The transformer lid of claim 16, characterized in that a the grounding wire or a grounding strap is utilized to connect the primary bushing to a grounding knob of the tank to achieve the an internal grounding, whereby lightning strikes may be transferred from the transformer to the ground.

18. The transformer lid of claim 1, characterized in that the lid portion comprises an outer lid portion and an inner lid portion.

19. The transformer lid of claim 18, characterized in that the outer lid portion and inner lid portion fit together and are attachable by the attachment means that is a sealable rim, said inner lid portion and outer lid portion fitting together in a manner that prevents moisture or particulates from entering the transformer housing.

20. The transformer lid of claim 1, characterized in that the being is an animal.

21. A method of preventing an animal landing upon a transformer from conducting electrical current flowing through the transformer, characterized in that it comprises the steps of:
(a) attaching an electrically non-conductive lid upon the transformer incorporating a grounding wire, said grounding wire connecting a primary bushing of the transformer to a grounding knob of a tank to achieve internal grounding; and
(b) utilizing the electrically non-conductive lid to isolate the animal from a ground grid when said animal rests on the lid by preventing the electrical current flowing through the transformer from flowing to a ground.

22. The method of claim 21, characterized in that it comprises the further step of preventing a power outage by isolating the animal resting on the lid from the ground grid.

23. The method of claim 21, characterized in that it comprises the further step of preventing serious harm to the animal by isolating the animal resting on the lid from the ground grid.
